(19) United States
(12) Patent Application Publication
(10) Pub. No.: US 2024/0353282 A1
(43) Pub. Date: Oct. 24, 2024

(54) FLUID LEAK DETECTION SENSOR, MANUFACTURING METHOD, AND FLUID LEAK DETECTION SENSOR SYSTEM INCLUDING THE SAME

(71) Applicant: KOREA UNIVERSITY RESEARCH AND BUSINESS FOUNDATION, Seoul (KR)

(72) Inventors: Daniel OH, Seoul (KR); Bee Lee CHUA, Seoul (KR); Kyung Nam KIM, Seoul (KR); Junxian QUAN, Seoul (KR); Xinyi SHI, Tianjin (CN)

(73) Assignee: KOREA UNIVERSITY RESEARCH AND BUSINESS FOUNDATION, Seoul (KR)

(21) Appl. No.: 18/624,195

(22) Filed: Apr. 2, 2024

(30) Foreign Application Priority Data
Apr. 11, 2023 (KR) 10-2023-0047734

(51) Int. Cl. G01M 3/18

(52) U.S. Cl. CPC G01M 3/18

(57) ABSTRACT

Provided is a fluid leak detection sensor system. The fluid leak detection sensor system includes: first and second electrodes spaced apart from each other; an absorption pad disposed between the first electrode and the second electrode to absorb a fluid; a first insulating tape disposed on the first electrode, and having a plurality of first holes; a second insulating tape disposed on the second electrode, and having a plurality of second holes; and an electronic unit control unit forming electrical contact points with the first electrode and the second electrode, wherein the electronic unit control unit includes: an alternating current signal generator; a peak detector circuit unit configured to measure a change in an impedance value between the first electrode and the second electrode according to the absorption of the fluid performed by the absorption pad; an electronic communication control unit; and a pair of pinch electrical connectors.

### CROSS-REFERENCE TO RELATED APPLICATION(S)

This application claims the benefit under 35 USC 119 (a) of Korean Patent Application No. 10-2023-0047734, with the Korean Intellectual Property Office on filed on Apr. 11, 2023, the disclosure of which is incorporated herein by reference in its entirety.

### BACKGROUND OF THE INVENTION

### 1. Field of the Invention

The present invention relates to a fluid leak detection sensor, a method for manufacturing the same, and a fluid leak detection sensor system including the same, and more particularly, to a fluid leak detection sensor including an absorption pad disposed between a pair of electrodes to absorb a fluid, a method for manufacturing the same, and a fluid leak detection sensor system including the same.

### 2. Description of the Related Art

A fluid leak detection sensor refers to a sensor configured to detect a leak state of a fluid.

The fluid leak detection sensor may be configured such that a resistance of a circuit within the fluid leak detection sensor is changed by leaked water or oil. Accordingly, the fluid leak detection sensor may serve to detect a leak state and a leak location of a fluid by detecting a change in a current or a voltage of the circuit.

Accordingly, the fluid leak detection sensor has been used in various industries such as water pipes in residential and commercial buildings.

As application fields increase, various fluid leak detection sensors are being researched. For example, Korean Patent Registration No. 10-1742160 discloses a fluid leak detection sensor including: a housing including a first sub-detection unit and a second sub-detection unit, which are coupled to and separated from each other so as to be detachably coupled to each other to surround a pipe part through which a fluid flows; and a leak detection printed circuit board formed on each of the first sub-detection unit and the second sub-detection unit, wherein the housing is configured such that the first sub-detection unit and the second sub-detection unit are coupled to and separated from each other so as to be detachably coupled to each other to surround the pipe part through which the fluid flows, which is connected to a connection part configured to connect two mutually different pipes to each other; the leak detection printed circuit board detects a leak by using a potential difference between conductive patterns having two mutually different polarities, which connect the two mutually different pipes to each other, according to a contact state with a leaked fluid; the detection of the leak is performed by providing a positive conductive pattern (+) and a negative conductive pattern (−), which are arranged not to make contact with each other to cover a leak area in which the fluid flows along an entire circumference of the pipe part, and generating mutually different potential differences between the positive conductive pattern (+) and the negative conductive pattern (−) according to a contact state of the conductive pattern with the leaked fluid; a connector configured to electrically connect the conductive pattern of the leak detection printed circuit board formed in the first sub-detection unit to the conductive pattern of the leak detection printed circuit board formed in the second sub-detection unit when the first sub-detection unit and the second sub-detection unit are coupled to each other is provided; a locking unit for locking and coupling the first sub-detection unit and the second sub-detection unit to each other is provided; and the housing including the first sub-detection unit and the second sub-detection unit, the leak detection printed circuit board formed on each of the first sub-detection unit and the second sub-detection unit, and the locking unit for locking and coupling the first sub-detection unit and the second sub-detection unit to each other are installed along a circumference of an end of the pipe part that is adjacent to the connection part so as to detect the fluid flowing through the connection part configured to connect the two mutually different pipes to each other.

### DOCUMENTS OF RELATED ART

### Patent Documents

(Patent Document 1) Korean Patent Registration No. 10-1742160

### SUMMARY OF THE INVENTION

One technical object of the present invention is to provide a fluid leak detection sensor capable of improving a sensing reaction speed for a fluid leak.

Another technical object of the present invention is to provide a fluid leak detection sensor capable of improving sensing sensitivity for a fluid leak.

Still another technical object of the present invention is to provide a fluid leak detection sensor capable of improving location accuracy for a fluid leak.

Yet another technical object of the present invention is to provide a method for manufacturing a fluid leak detection sensor, capable of reducing a manufacturing process cost.

Still yet another technical object of the present invention is to provide a method for manufacturing a fluid leak detection sensor, capable of shortening a manufacturing time.

Another technical object of the present invention is to provide a method for manufacturing a fluid leak detection sensor, capable of facilitating mass production.

Technical objects of the present invention are not limited to the above-described technical objects.

To achieve the technical objects described above, the present invention provides a fluid leak detection sensor system.

According to one embodiment, the fluid leak detection sensor system includes: first and second electrodes spaced apart from each other; an absorption pad disposed between the first electrode and the second electrode to absorb a fluid; a first insulating tape disposed on the first electrode, and having a plurality of first holes; a second insulating tape disposed on the second electrode, and having a plurality of second holes; and an electronic unit control unit forming electrical contact points with the first electrode and the second electrode through the first hole and the second hole, wherein the electronic unit control unit includes: an alternating current signal generator configured to apply an alternating current to the first electrode and the second electrode through the first hole and the second hole; a peak detector circuit unit configured to measure a change in an impedance value between the first electrode and the second electrode according to the absorption of the fluid performed by the absorption pad; an electronic communication control unit configured to control the alternating current signal generator and the peak detector circuit unit; and a pair of pinch electrical connectors configured to connect the electrical contact points formed by the first hole and the second hole to the alternating current signal generator.

According to one embodiment, the fluid may include: an ionic liquid including tap water, seawater, an acidic solution, a basic solution, or a biological fluid; or an electrically insulating liquid including hydrocarbon oil, synthetic oil, a polymer fluid, or pure water.

According to one embodiment, the first electrode and the second electrode may be spaced apart from each other with the absorption pad interposed therebetween without an air gap, the first electrode, the absorption pad, and the second electrode may be sandwiched between the first insulating tape and the second insulating tape, and the first hole and the second hole may expose the first electrode and the second electrode, respectively.

According to one embodiment, each of the first electrode and the second electrode may include at least one of metal foil, a conductive coating layer on fabric, or a conductive polymer, the absorption pad may include at least one of paper, cotton, or a polymer, and the first electrode, the second electrode, and the absorption pad may be fixed to each other by using one of sewing, heat bonding, ultrasonic bonding, or an adhesive.

According to one embodiment, a capacitance value or a resistance value between the first electrode and the second electrode may be changed according to a state of the absorption of the fluid performed by the absorption pad and an absorption amount of the fluid, when the absorption of the fluid is not performed by the absorption pad, a portion between the first electrode and the second electrode may be modeled as a pure capacitor circuit, when the absorption of the fluid including an ionic liquid is performed by the absorption pad, a portion between the first electrode and the second electrode may be modeled as a Randles circuit having a first resistor and a first capacitor connected in parallel with each other, and a second resistor connected in series with the first resistor and the first capacitor in the pure capacitor circuit, so that an impedance value between the first electrode and the second electrode may be reduced, and the reduced impedance value may be measured by the peak detector circuit unit, and, when the absorption of the fluid including an electrically insulating liquid is performed by the absorption pad, a dielectric constant of the absorption pad between the first electrode and the second electrode may be reduced to reduce the impedance value, and the reduced impedance value may be measured by the peak detector circuit unit.

According to one embodiment, the electronic communication control unit may include: a data logger configured to store a peak voltage and a value calculated from the peak voltage; a microcontroller configured to control a duty cycle and a peak voltage sampling rate, and perform calculation for determining a leak location of the fluid, in which the leak location of the fluid is determined by using an impedance value measured through a peak voltage change measured by the peak detector circuit unit; and a communication module configured to receive the leak location of the fluid from the microcontroller, and including one of Wi-Fi, Bluetooth, ZigBee, infrared communication, RF wireless communication, or Ethernet.

According to one embodiment, the alternating current signal generator may generate at least one of a sine wave, a square wave, or a sawtooth wave of 1 Hz to 1 MHz to apply the generated wave to the first electrode and the second electrode.

To achieve the technical objects described above, the present invention provides a method for manufacturing a fluid leak detection sensor of the fluid leak detection sensor system described above.

According to one embodiment, the method for manufacturing the fluid leak detection sensor includes: preparing an absorption pad extending in a first direction; preparing a pair of electrodes extending in the first direction; preparing a pair of insulating tapes extending in the first direction and having a plurality of holes spaced apart from each other in the first direction; and arranging the absorption pad between the pair of electrodes, and arranging the pair of electrodes and the absorption pad between the pair of insulating tapes.

According to one embodiment, the arranging of the absorption pad between the pair of electrodes and the arranging of the pair of electrodes and the absorption pad between the pair of insulating tapes may be performed by using a roll-to-roll process.

According to one embodiment, the absorption pad may include at least one of paper, fabric, non-woven fabric, or a polymer.

According to one embodiment, the electrode may include aluminum foil, and the insulating tape may include a masking tape.

To achieve the technical objects described above, the present invention provides a fluid leak detection sensor manufactured by the method for manufacturing the fluid leak detection sensor, which is described above.

According to one embodiment, the fluid leak detection sensor includes: an absorption pad extending in a first direction to absorb a fluid; a first electrode disposed on a top of the absorption pad, and extending in the first direction; a second electrode disposed at a bottom of the absorption pad, and extending in the first direction; a first insulating tape disposed on the first electrode, extending in the first direction, and having a plurality of first holes spaced apart from each other in the first direction; and a second insulating tape disposed on the second electrode, extending in the first direction, and having a plurality of second holes spaced apart from each other in the first direction, wherein the fluid is absorbed into an exposure surface of the absorption pad disposed between the first electrode and the second electrode.

According to one embodiment, the first hole of the first insulating tape and the second hole of the second insulating tape may overlap each other.

According to one embodiment, an adhesive tape may be disposed on the second insulating tape, and the adhesive tape may have a third hole, which overlaps the second hole of the second insulating tape and is identical to the second hole.

To achieve the technical objects described above, the present invention provides a fluid leak detection sensor system adopting the fluid leak detection sensor described above.

According to one embodiment, the fluid leak detection sensor system includes: a pipe through which a fluid flows; a fluid leak detection sensor disposed on the pipe; and an electronic unit control unit configured to connect a first contact point of a first electrode exposed by a first hole of a first insulating tape to a second contact point of a second electrode exposed by a second hole of a second insulating tape within the fluid leak detection sensor, wherein the electronic unit control unit outputs different according to an introduction state of the fluid into an absorption pad of the fluid leak detection sensor through the first contact point of the fluid leak detection sensor and the second contact point of the fluid leak detection sensor, which overlaps the first contact point, to determine whether the fluid leaks from an inside of the pipe.

To achieve the technical objects described above, the present invention provides a method for using the fluid leak detection sensor described above.

According to one embodiment, there is provided the method for using the fluid leak detection sensor, wherein the fluid leak detection sensor is attached to a pipe through which a fluid flows or a structure in which the pipe is installed in a spiral shape.

According to an embodiment of the present invention, a method for manufacturing a fluid leak detection sensor may include arranging an absorption pad between a pair of electrodes and arranging the pair of electrodes and the absorption pad between a pair of insulating tapes having a plurality of holes, by performing a roll-to-roll process. Therefore, according to the method for manufacturing the fluid leak detection sensor by performing the roll-to-roll process, a manufacturing process of the fluid leak detection sensor can be simplified, so that a manufacturing time of the fluid leak detection sensor can be shortened. Accordingly, a manufacturing cost of the fluid leak detection sensor can be reduced, so that mass production of the fluid leak detection sensor can be facilitated.

According to an embodiment of the present invention, a fluid leak detection sensor may include an absorption pad disposed between a pair of electrodes, and a pair of electrode exposure surfaces formed on the pair of electrodes and exposed by a plurality of holes formed on the pair of insulating tapes. Accordingly, the pair of electrode exposure surfaces of the fluid leak detection sensor may be connected to an electronic unit control unit configured to detect a difference in a sensing voltage between the electrodes according to introduction of a fluid into the absorption pad. Accordingly, a fluid leak detection sensor system including the fluid leak detection sensor capable of improving a sensing reaction speed, sensing sensitivity, and location accuracy for a fluid leak can be provided. Accordingly, the fluid leak detection sensor system can be used in various industries capable of monitoring a fluid leak, such as water pipes in residential and commercial buildings.

### BRIEF DESCRIPTION OF THE DRAWINGS

FIG. 1 is a view for describing a fluid leak detection sensor system according to an embodiment of the present invention.

FIG. 2 is a view for describing an alternating current signal generator of the fluid leak detection sensor system according to the embodiment of the present invention.

FIG. 3 is a view for describing a circuit model between a first electrode and a second electrode according to introduction of a fluid in the fluid leak detection sensor system according to the embodiment of the present invention.

FIG. 4 is a view for describing an electronic communication control unit of the fluid leak detection sensor system according to the embodiment of the present invention.

FIG. 5 is a flowchart 1 for describing a method for manufacturing a fluid leak detection sensor according to an embodiment of the present invention.

FIG. 6 is an exploded view showing an absorption pad, a first electrode, a second electrode, a first insulating tape, and a second insulating tape to describe the method for manufacturing the fluid leak detection sensor according to the embodiment of the present invention.

FIG. 7 is a sectional view for describing the method for manufacturing the fluid leak detection sensor according to the embodiment of the present invention.

FIG. 8 is a three-dimensional view for describing the method for manufacturing the fluid leak detection sensor according to the embodiment of the present invention.

FIG. 9 is a sectional view showing a fluid leak detection sensor according to an embodiment of the present invention.

FIG. 10 is a three-dimensional view showing the fluid leak detection sensor according to the embodiment of the present invention.

FIG. 11 is a photograph showing the fluid leak detection sensor according to the embodiment of the present invention.

FIG. 12 is a view for describing a process of manufacturing the fluid leak detection sensor according to the embodiment of the present invention in the form of a tape, and attaching the fluid leak detection sensor to a pipe.

FIG. 13 is a view for describing a fluid leak detection sensor according to a first modified example of the present invention.

(a) of FIG. 14 is a graph obtained by theoretically calculating a sensing voltage of a fluid leak detection sensor according to an embodiment of the present invention for each driving frequency condition of the fluid leak detection sensor before and after a leak.

(b) of FIG. 14 is a graph showing a difference in the sensing voltage of the fluid leak detection sensor according to the embodiment of the present invention for each driving frequency condition of the fluid leak detection sensor.

FIG. 15 is a view for describing a test method for a fluid leak detection sensor according to an embodiment of the present invention.

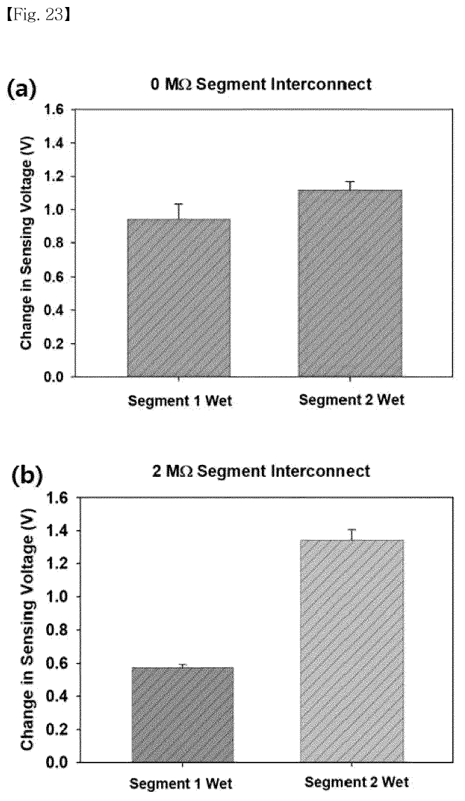

(a) to (c) of FIG. 16 are graphs obtained by measuring the sensing voltage of the fluid leak detection sensor according to the embodiment of the present invention by the test method of FIG. 15.

(d) of FIG. 16 is a graph showing an average sensing voltage of the fluid leak detection sensor according to the embodiment of the present invention, which is obtained based on the sensing voltages measured in (a) to (c) of FIG. 16.

(a) to (d) of FIG. 17 are graphs obtained by measuring the sensing voltage of the fluid leak detection sensor according to the embodiment of the present invention for each sine wave driving frequency condition.

(a) of FIG. 18 is a graph obtained by measuring a sensing voltage by applying a sine wave driving frequency of 5 kHz to the fluid leak detection sensor according to the embodiment of the present invention.

(b) of FIG. 18 is a graph showing a difference in the sensing voltages of the fluid leak detection sensor according to the embodiment of the present invention, which are measured in (a) to (d) of FIG. 17 and (a) of FIG. 18.

(a) to (c) of FIG. 19 are graphs obtained by measuring a sensing voltage by applying a square wave driving frequency to the fluid leak detection sensor according to the embodiment of the present invention.

(d) of FIG. 19 is a graph showing an average value of the sensing voltages of the fluid leak detection sensor according to an experimental example of the present invention, which are measured in (a) to (c) of FIG. 19.

(a) of FIG. 20 is a graph for comparing differences in sensing voltages measured according to a type of a driving frequency applied to the fluid leak detection sensor according to the embodiment of the present invention.

(b) of FIG. 20 is a graph for comparing differences in sensing voltages measured according to a volume of a water droplet provided to the fluid leak detection sensor according to the embodiment of the present invention.

(a) of FIG. 21 is a view for describing first and second test methods for a fluid leak detection sensor according to an embodiment of the present invention.

(b) of FIG. 21 is a graph obtained by measuring a sensing voltage by applying a resistor to the fluid leak detection sensor of the present invention according to the first test method.

(c) of FIG. 21 is a graph showing an average value of the sensing voltages of the fluid leak detection sensor according to the embodiment of the present invention, which are measured in (b) of FIG. 21.

(d) of FIG. 21 is a graph for comparing standard deviations of differences in the sensing voltages of the fluid leak detection sensor of the present invention according to the first and second test methods.

(a) of FIG. 22 is a view for describing third and fourth test methods for a fluid leak detection sensor according to an embodiment of the present invention.

(b) of FIG. 22 is a graph showing sensing voltages of a first segment and a second segment according to the third test method.

(c) of FIG. 22 is a graph showing sensing voltages of the first segment and the second segment according to the fourth test method.

(a) of FIG. 23 is a graph showing differences in the sensing voltages of the first segment and the second segment, which are measured in (b) of FIG. 22.

(b) of FIG. 23 is a graph showing differences in the sensing voltages of the first segment and the second segment, which are measured in (c) of FIG. 22.

### DETAILED DESCRIPTION OF THE INVENTION

Hereinafter, exemplary embodiments of the present invention will be described in detail with reference to the accompanying drawings. However, the technical idea of the present invention is not limited to the embodiments described herein, but may be embodied in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, thicknesses of films and regions are exaggerated for effective description of the technical contents.

In addition, although the terms such as first, second, and third have been used to describe various elements in various embodiments of the present disclosure, the elements are not limited by the terms. The terms are used only to distinguish one element from another element. Therefore, an element mentioned as a first element in one embodiment may be mentioned as a second element in another embodiment. The embodiments described and illustrated herein include their complementary embodiments, respectively. Further, the term “and/or” used in the present disclosure is used to include at least one of the elements enumerated before and after the term.

As used herein, an expression in a singular form includes a meaning of a plural form unless the context clearly indicates otherwise. Further, the terms such as “including” and “having” are intended to designate the presence of features, numbers, steps, elements, or combinations thereof described in the present disclosure, and shall not be construed to preclude any possibility of the presence or addition of one or more other features, numbers, steps, elements, or combinations thereof.

Further, in the following description of the present invention, detailed descriptions of known functions or configurations incorporated herein will be omitted when they may make the gist of the present invention unnecessarily unclear.

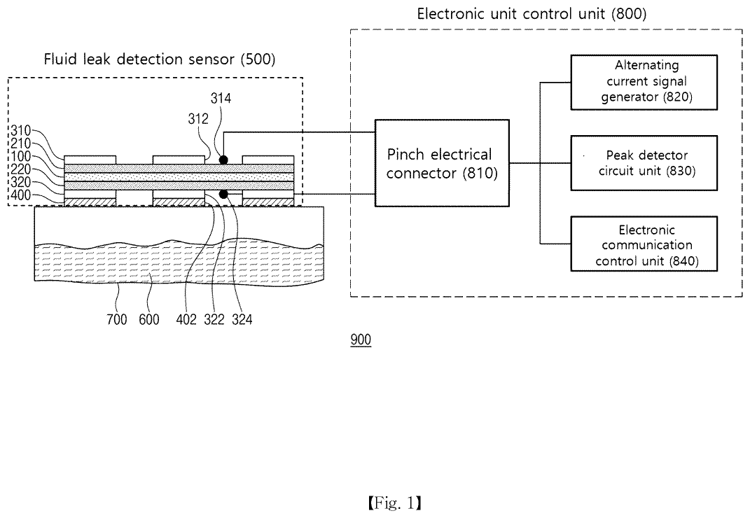

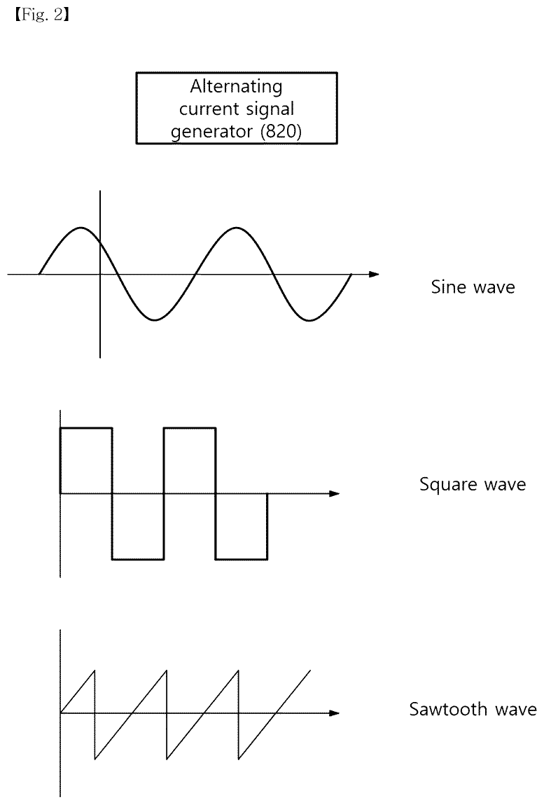

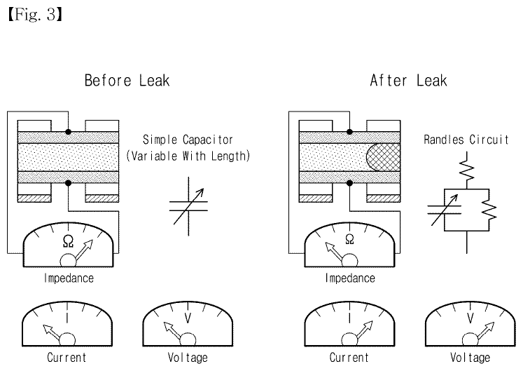

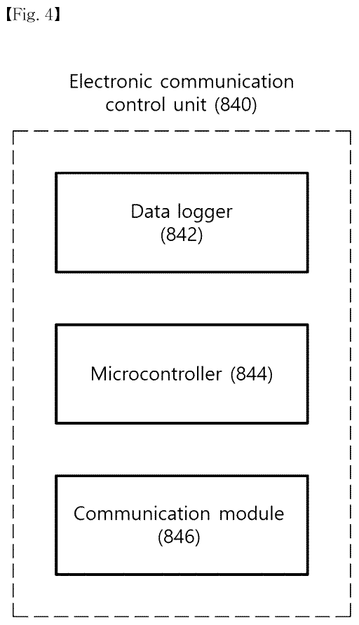

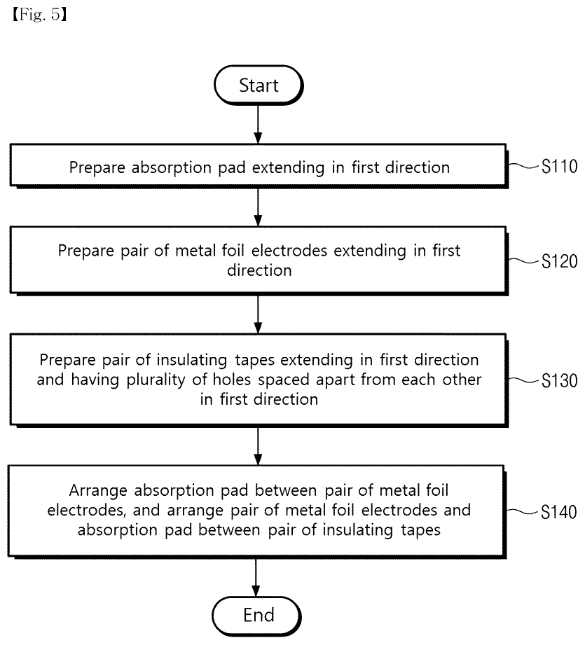

FIG. 1 is a view for describing a fluid leak detection sensor system according to an embodiment of the present invention, FIG. 2 is a view for describing an alternating current signal generator of the fluid leak detection sensor system according to the embodiment of the present invention, FIG. 3 is a view for describing a circuit model between a first electrode and a second electrode according to introduction of a fluid in the fluid leak detection sensor system according to the embodiment of the present invention, and FIG. 4 is a view for describing an electronic communication control unit of the fluid leak detection sensor system according to the embodiment of the present invention.

Referring to FIG. 1, a fluid leak detection sensor system 900 may include a pipe 700 through which a fluid 600 flows, a fluid leak detection sensor 500 attached onto the pipe 700, and an electronic unit control unit 800.

For example, the fluid 600 may be an ionic liquid including at least one of tap water, seawater, an acidic solution, a basic solution, or a biological fluid. For another example, the fluid 600 may be an electrically insulating liquid including at least one of hydrocarbon oil, synthetic oil, a polymer fluid, or pure water.

For example, the pipe 700 may be one of a hot water pipe, a heating pipe, a cooling pipe, a waste/sewage water pipe, or a firefighting pipe.

As will be described below with reference to FIGS. 5 to 10, the fluid leak detection sensor 500 may include: first and second electrodes 210 and 220 spaced apart from each other; an absorption pad 100 disposed between the first electrode 210 and the second electrode 220 to absorb a fluid 600; a first insulating tape 310 disposed on the first electrode 210, and having a plurality of first holes 312; and a second insulating tape 320 disposed on the second electrode 220, and having a plurality of second holes 322. Therefore, the fluid leak detection sensor 500 may have a first electrode exposure surface and a second electrode exposure surface, which expose the first electrode 210 and the second electrode 220, respectively, by the first holes 312 and the second holes 322. Accordingly, the fluid leak detection sensor 500 may be connected to the electronic unit control unit 800 through electrical contact points (a first contact point 314 and a second contact point 324) formed on the first electrode exposure surface and the second electrode exposure surface. The first contact point 314 and the second contact point 324 of the fluid leak detection sensor 500 may be disposed on the first electrode exposure surface and the second electrode exposure surface disposed at an extreme end of the fluid leak detection sensor 500, respectively.

The electronic unit control unit 800 may include a pair of pinch electrical connectors 810, an alternating current signal generator 820, a peak detector circuit unit 830, and an electronic communication control unit 840.

One ends of the pair of pinch electrical connectors 810 may be connected to the first contact point 314 and the second contact point 324, respectively, and opposite ends of the pair of pinch electrical connectors 810 may be connected to the alternating current signal generator 820.

Referring to FIGS. 1 and 2, the alternating current signal generator 820 may apply an alternating current and a driving frequency to the first electrode 210 and the second electrode 220 of the fluid leak detection sensor 500 through the first contact point 314 and the second contact point 324. For example, a form of the driving frequency may be one of a sine wave, a square wave, or a sawtooth wave. For example, an intensity of the driving frequency may be 1 Hz to 1 MHz. Therefore, the alternating current and the driving frequency generated by the alternating current signal generator 820 may be transmitted to the first electrode 210 and the second electrode 220 through the first contact point 314 and the second contact point 324 via the pair of pinch electrical connectors 810.

Referring to FIGS. 1 and 3, the peak detector circuit unit 830 may measure a change in a peak voltage through a capacitance value or a resistance value between the first electrode 210 and the second electrode 220 changed according to a state of the absorption of the fluid 600 performed by the absorption pad 100 of the fluid leak detection sensor 500 and an absorption amount of the fluid 600. Accordingly, the peak detector circuit unit 830 may measure a change in an impedance value through the change in the peak voltage.

Therefore, when the absorption of the fluid 600 is not performed by the absorption pad 100, a portion between the first electrode 210 and the second electrode 220 may be modeled as a pure capacitor circuit.

In contrast, when the absorption of the fluid 600 including an ionic liquid is performed by the absorption pad 100, a portion between the first electrode 210 and the second electrode 220 may be modeled as a Randles circuit having a first resistor and a first capacitor connected in parallel with each other, and a second resistor connected in series with the first resistor and the first capacitor in the pure capacitor circuit. Accordingly, the capacitance value or the resistance value between the first electrode 210 and the second electrode 220 may be reduced, and a value of the peak voltage may be reduced, so that a reduced impedance value may be measured by the peak detector circuit unit 830.

Meanwhile, when the absorption of the fluid 600 including an electrically insulating liquid is performed by the absorption pad 100, a dielectric constant of the absorption pad 100 between the first electrode 210 and the second electrode 220 may be reduced. Accordingly, the capacitance value or the resistance value between the first electrode 210 and the second electrode 220 may be reduced, and the value of the peak voltage may be reduced, so that a reduced impedance value may be measured by the peak detector circuit unit 830.

Referring to FIGS. 1 and 4, the electronic communication control unit 840 may control the alternating current signal generator 820 and the peak detector circuit unit 830, and may include a data logger 842, a microcontroller 844, and a communication module 846.

The data logger 842 may store the peak voltage of the peak detector circuit unit 830 and a value calculated from the peak voltage.

The microcontroller 844 may control a duty cycle and a peak voltage sampling and may perform calculation for determining a leak location of the fluid 600. Therefore, the leak location of the fluid 600 may be determined by using an impedance value measured according to a peak voltage change measured by the peak detector circuit unit 830.

The communication module 846 may receive the leak location of the fluid 600 from the microcontroller 844. For example, the communication module 846 may include one of Wi-Fi, Bluetooth, infrared communication, RF wireless communication, or Ethernet.

Therefore, while the alternating current and the driving frequency generated by the alternating current signal generator 820 of the electronic unit control unit 800 are applied to the fluid leak detection sensor 500, the capacitance value or the resistance value between the first electrode 210 and the second electrode 220 may be changed according to an introduction state of the fluid 600 into the absorption pad 100 of the fluid leak detection sensor 500 and the absorption amount of the fluid 600. Accordingly, a difference in a sensing voltage value (or the impedance value or the peak voltage value) may be measured through the peak detector circuit unit 830 and the electronic communication control unit 840 of the electronic unit control unit 800. Accordingly, the fluid leak detection sensor system 900 may determine a leak state and the leak location of the fluid 600.

In detail, when the fluid 600 leaks to an outside of the pipe 700, the fluid 600 may be absorbed through an exposure surface of the absorption pad 100 disposed between the first electrode 210 and the second electrode 220 of the fluid leak detection sensor 500. Therefore, the capacitance or resistance value between the first electrode 210 and the second electrode 220 may be reduced. In this case, the peak detector circuit unit 830 of the electronic unit control unit 800 may detect a change in the sensing voltage value through the first contact point 314 formed on a top surface of the first electrode exposure surface and the second contact point 324 formed on a top surface of the second electrode exposure surface. Accordingly, the electronic communication control unit 840 of the electronic unit control unit 800 may calculate the difference in the sensing voltage value to determine the leak state and the leak location of the fluid 600.

According to one embodiment, the fluid leak detection sensor system 900 may be configured such that a length of the fluid leak detection sensor 500 is, for example, 100 mm. The alternating current signal generator 820 may apply a sine wave driving frequency. For example, the sine wave driving frequency may be 10 Hz. In this case, the fluid leak detection sensor system 900 may determine the leak state and the leak location of the fluid 600 within 100 mm within 5 seconds, and a volume of the fluid 600 that may be detected may be up to 5 uL.

Therefore, the fluid leak detection sensor system 900 according to the present invention may improve a sensing reaction speed, sensing sensitivity, and accuracy of the leak location for a leak of the fluid 600. Accordingly, the fluid leak detection sensor system 900 may be used in various industries capable of monitoring the leak of the fluid, such as water pipes in residential and commercial buildings.

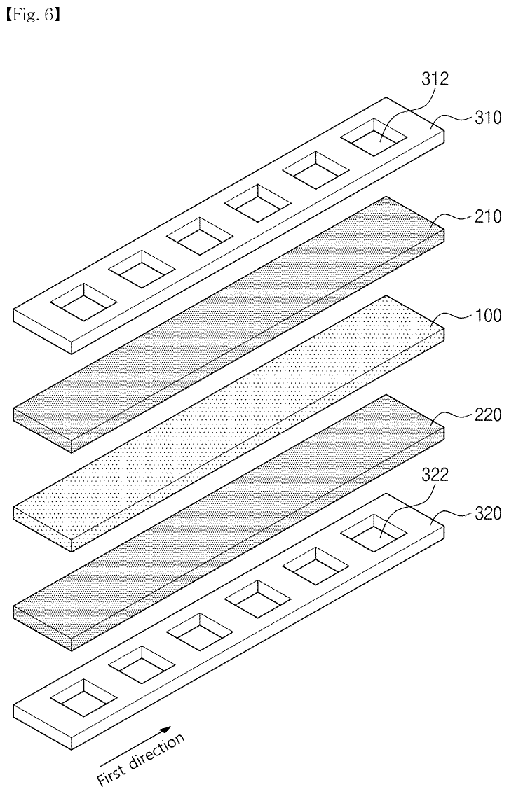

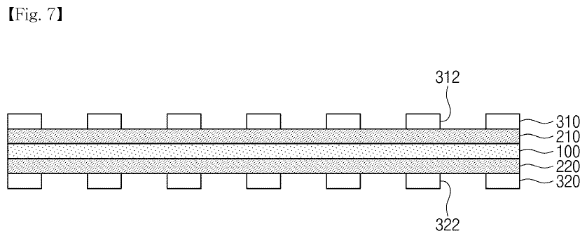

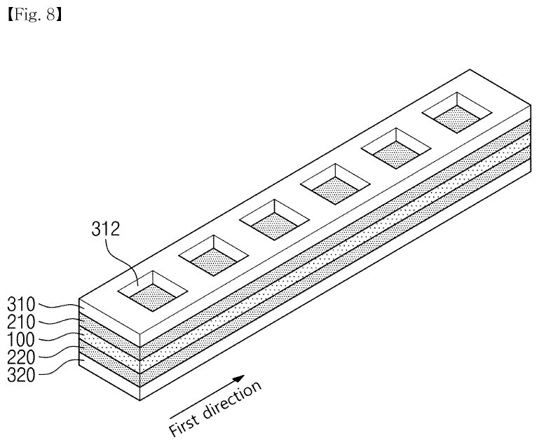

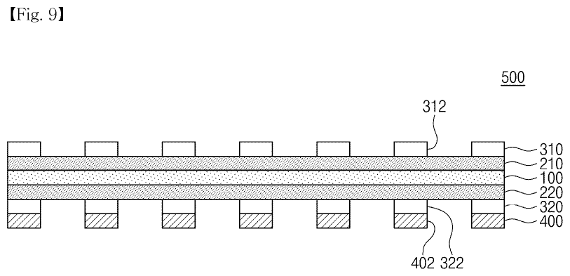

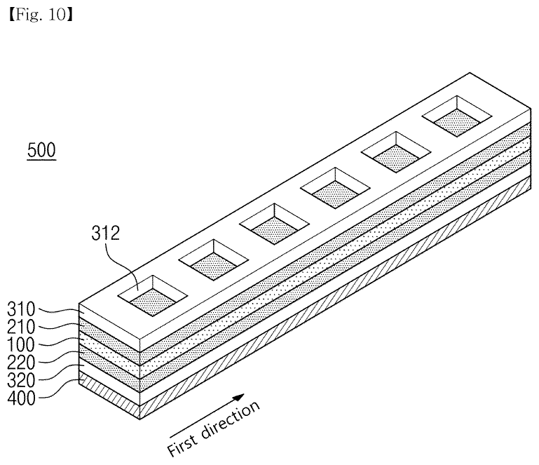

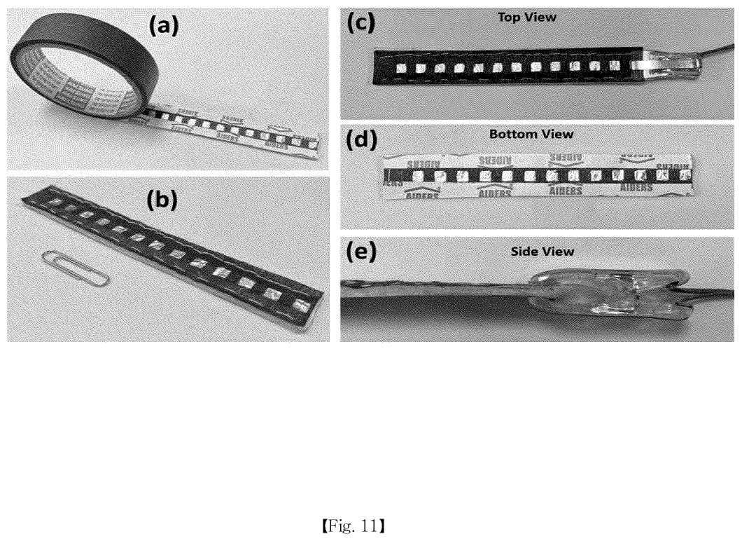

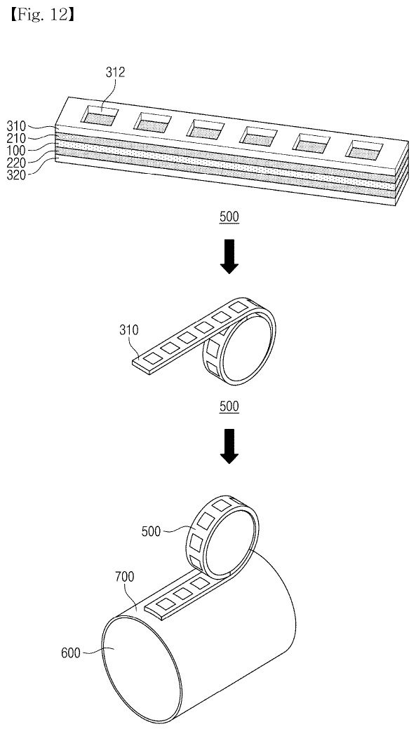

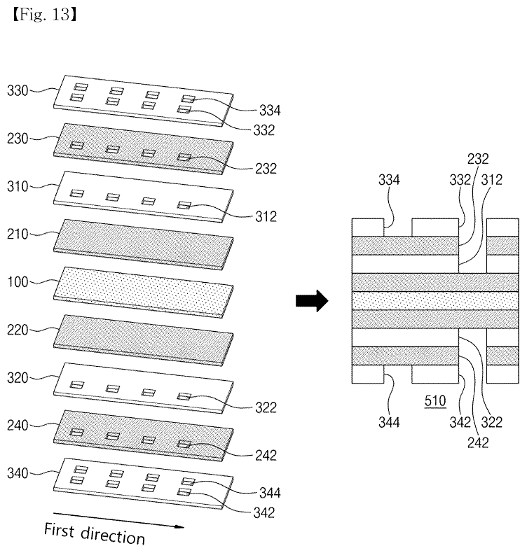

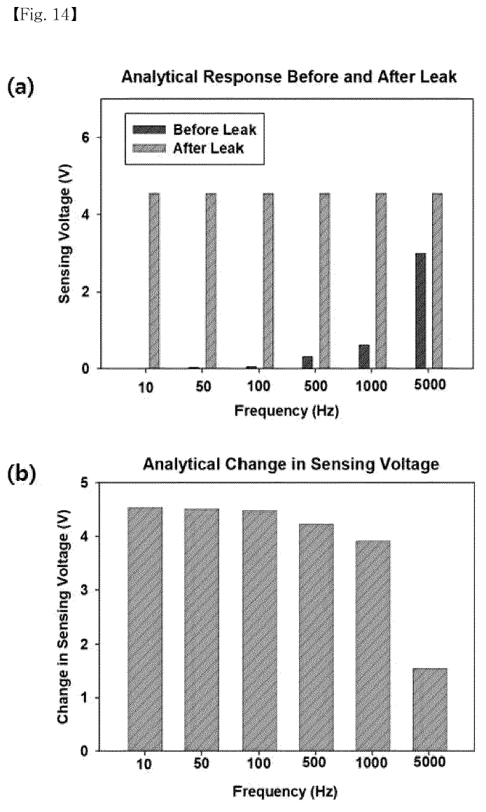

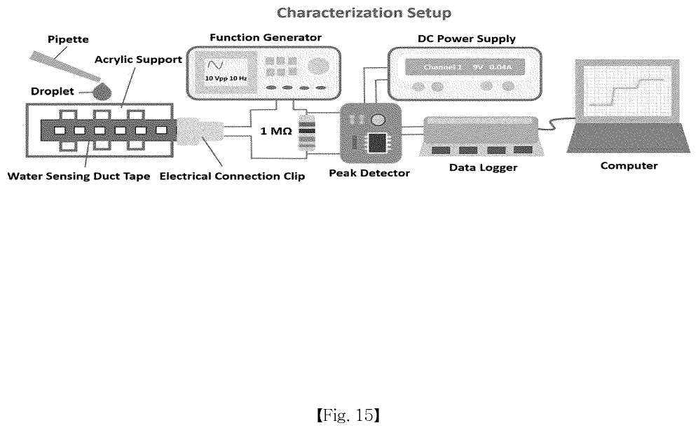

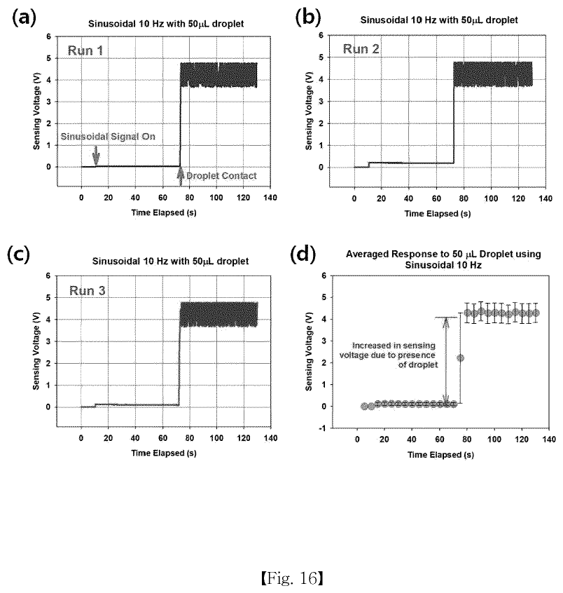

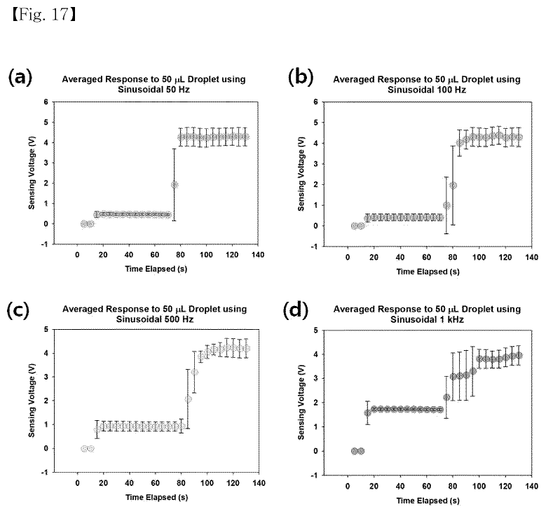

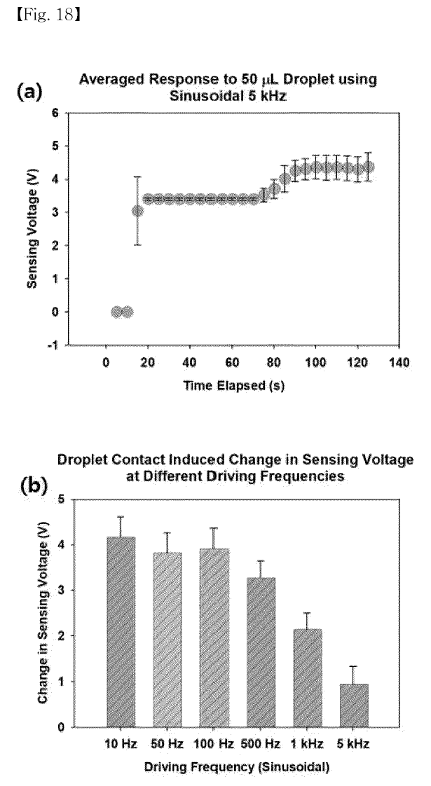

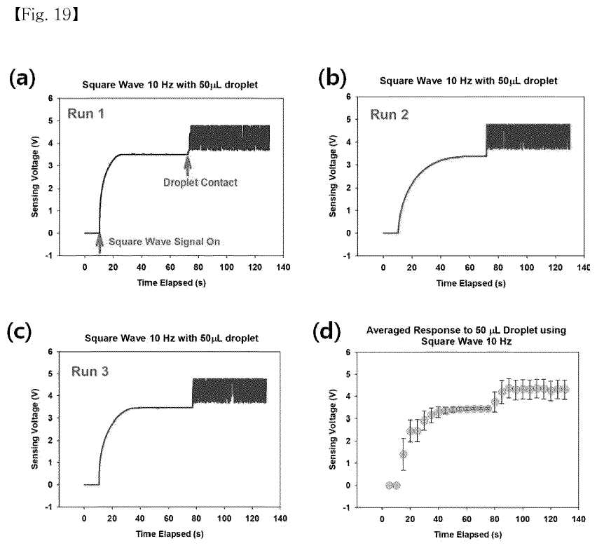

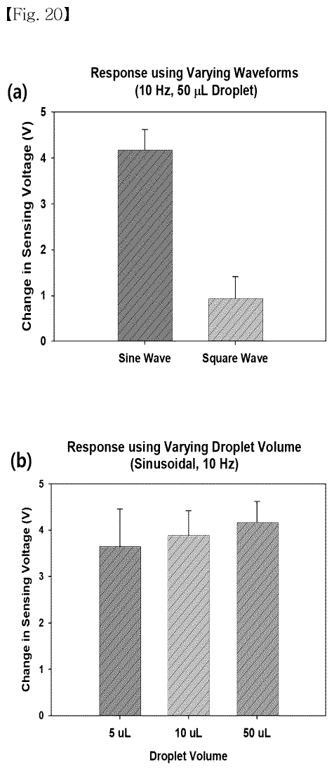

FIG. 5 is a flowchart for describing a method for manufacturing a fluid leak detection sensor according to an embodiment of the present invention, FIG. 6 is an exploded view showing an absorption pad, a first electrode, a second electrode, a first insulating tape, and a second insulating tape to describe the method for manufacturing the fluid leak detection sensor according to the embodiment of the present invention, FIG. 7 is a sectional view for describing the method for manufacturing the fluid leak detection sensor according to the embodiment of the present invention, FIG. 8 is a three-dimensional view for describing the method for manufacturing the fluid leak detection sensor according to the embodiment of the present invention, FIG. 9 is a sectional view showing a fluid leak detection sensor according to an embodiment of the present invention, FIG. 10 is a three-dimensional view showing the fluid leak detection sensor according to the embodiment of the present invention, FIG. 11 is a photograph showing the fluid leak detection sensor according to the embodiment of the present invention, and FIG. 12 is a view for describing a process of manufacturing the fluid leak detection sensor according to the embodiment of the present invention in the form of a tape, and attaching the fluid leak detection sensor to a pipe.

Referring to FIGS. 5 and 6, an absorption pad 100 extending in a first direction may be prepared (S110).

As described above, the absorption pad 100 may be disposed between a first electrode 210 and a second electrode 220, which are spaced apart from each other. Therefore, the absorption pad 100 may have an exposure surface between the first electrode 210 and the second electrode 220. Accordingly, the absorption pad 100 may absorb a fluid through the exposure surface of the absorption pad 100. For example, the absorption pad 100 may be formed of paper, cotton, or a polymer.

Referring to FIGS. 5 and 6, a pair of electrodes 210 and 220 extending in the first direction may be prepared (S120).

The first electrode 210 may be disposed on a top of the absorption pad 100, and may extend in the first direction. In addition, the second electrode 220 may be disposed at a bottom of the absorption pad 100, and may extend in the first direction. For example, each of the first electrode 210 and the second electrode 220 may be formed of at least one of metal foil, a conductive coating layer on fabric, or a conductive polymer. In detail, each of the first electrode 210 and the second electrode 220 may be formed of aluminum foil.

Referring to FIGS. 5 and 6, a pair of the insulating tapes 310 and 320 extending in the first direction and having a plurality of holes 312 and 322 spaced apart from each other in the first direction may be prepared (S130).

A first insulating tape 310 may be disposed on the first electrode 210, may extend in the first direction, and may have a plurality of first holes 312 spaced apart from each other in the first direction. In addition, a second insulating tape 320 may be disposed on the second electrode 220, may extend in the first direction, and may have a plurality of second holes 322 spaced apart from each other in the first direction. For example, each of the first insulating tape 310 and the second insulating tape 320 may be a masking tape.

Referring to FIGS. 5 to 8, the absorption pad 100 may be arranged between the pair of electrodes 210 and 220, and the pair of the electrodes 210 and 220 and the absorption pad 100 may be arranged between the pair of insulating tapes 310 and 320 (S140).

For example, the arranging of the absorption pad 100 between the pair of electrodes 210 and 220 and the arranging of the pair of electrodes 210 and 220 and the absorption pad 100 between the pair of insulating tapes 310 and 320 may be performed by using one of a roll-to-roll process, sewing, heat bonding, ultrasonic bonding, or adhesive bonding.

According to one embodiment, the arranging of the absorption pad 100 between the pair of electrodes 210 and 220 and the arranging of the pair of electrodes 210 and 220 and the absorption pad 100 between the pair of insulating tapes 310 and 320 may be performed by using one of a roll-to-roll process may be performed by using the roll-to-roll process.

The roll-to-roll process may be performed so that the first electrode 210 may be arranged on the top of the absorption pad 100, and the second electrode 220 may be arranged at the bottom of the absorption pad 100. Therefore, an air gap may not exist between the first electrode 210 and the absorption pad 100, and between the second electrode 220 and the absorption pad 100.

In addition, the first insulating tape 310 having the first holes 312 may be arranged on the first electrode 210, and the second insulating tape 320 having the second holes 322 may be arranged on the second electrode 220. Therefore, the first electrode 210 and the second electrode 220 may be arranged between the first insulating tape 310 and the second insulating tape 320, and the absorption pad 100 may be arranged between the first electrode 210 and the second electrode 220. In other words, the first electrode 210, the absorption pad 100, and the second electrode 220 may be sandwiched between the first insulating tape 310 and the second insulating tape 320.

In detail, at least some of the first holes 312 of the first insulating tape 310 and the second holes 322 of the second insulating tape 320 may overlap each other on a one-to-one basis. Therefore, a plurality of first electrode exposure surfaces may be formed on a top surface of the first electrode 210 by the first holes 312. In addition, a plurality of second electrode exposure surfaces may be formed on a top surface of the second electrode 220 by the second holes 322. Accordingly, similar to at least some of the first holes 312 and the second holes 322 overlapping each other on a one-to-one basis, at least some of the first electrode exposure surfaces and the second electrode exposure surfaces may overlap each other on a one-to-one basis.

Referring to FIGS. 9 to 11, an adhesive tape 400 extending in the first direction may be arranged on the second insulating tape 320 to manufacture a fluid leak detection sensor 500 according to the present invention.

The adhesive tape 400 may have a plurality of third holes 402 spaced apart from each other in the first direction. At least some of the third holes 402 and the second holes 322 of the second insulating tape 320 may overlap each other on a one-to-one basis. In addition, the adhesive tape 400 may be disposed on the second insulating tape 320 to attach the fluid leak detection sensor 500 to a pipe through which the fluid flows or a structure in which the pipe is installed. For example, the adhesive tape 400 may be a double-sided tape.

According to one embodiment, the arranging of the adhesive tape 400 on the second insulating tape 320 may be performed by the roll-to-roll process described above.

Referring to FIG. 12, the fluid leak detection sensor 500 may be manufactured in the form of a tape by performing the roll-to-roll process described above.

As described above, the fluid leak detection sensor 500 manufactured in the form of a tape may be attached to the pipe through which the fluid flows or the structure in which the pipe is installed in a straight line shape or a spiral shape by the adhesive tape 400 disposed on the second insulating tape 320 of the fluid leak detection sensor 500.

For example, an area in which a leak location of the fluid may be detected may be increased in a case in which the fluid leak detection sensor 500 is attached to the pipe through which the fluid flows or the structure in which the pipe is installed in the spiral shape as compared with a case in which the fluid leak detection sensor 500 is attached in the straight line shape, so that the leak location of the fluid may be accurately determined. Therefore, according to a method for using a fluid leak detection sensor 500 by attaching the fluid leak detection sensor 500 to the pipe through which the fluid flows or the structure in which the pipe is installed in the spiral shape, accuracy of the fluid leak detection sensor 500 for the leak location of the fluid may be improved.

According to the method for manufacturing the fluid leak detection sensor 500 of the present invention, when the roll-to-roll process is performed, a manufacturing process of the fluid leak detection sensor 500 may be simplified, so that a manufacturing time of the fluid leak detection sensor 500 may be shortened. Accordingly, a manufacturing cost of the fluid leak detection sensor 500 may be reduced, so that mass production of the fluid leak detection sensor 500 may be facilitated.

The fluid leak detection sensor 500 according to the present invention manufactured according to the method described above may include: an absorption pad 100 configured to absorb a fluid; a first electrode 210 disposed on a top of the absorption pad 100, and extending in a first direction; a second electrode 220 disposed at a bottom of the absorption pad 100, and extending in the first direction; a first insulating tape 310 disposed on the first electrode 210, extending in the first direction, and having a plurality of first holes 312 spaced apart from each other in the first direction; and a second insulating tape 320 disposed on the second electrode 220, extending in the first direction, and having a plurality of second holes 322 spaced apart from each other in the first direction.

Therefore, the fluid leak detection sensor 500 may have a first electrode exposure surface and a second electrode exposure surface, which expose the first electrode 210 and the second electrode 220, respectively, by the holes 322 and the holes 322. Accordingly, the fluid leak detection sensor 500 may be connected to the electronic unit control unit 800 through the first contact point 314 and the second contact point 324 formed on the first electrode exposure surface and the second electrode exposure surface.

Accordingly, a fluid leak detection sensor system 900 capable of improving a sensing reaction speed, sensing sensitivity, and leak location accuracy for a fluid leak may be provided by using the fluid leak detection sensor 500.

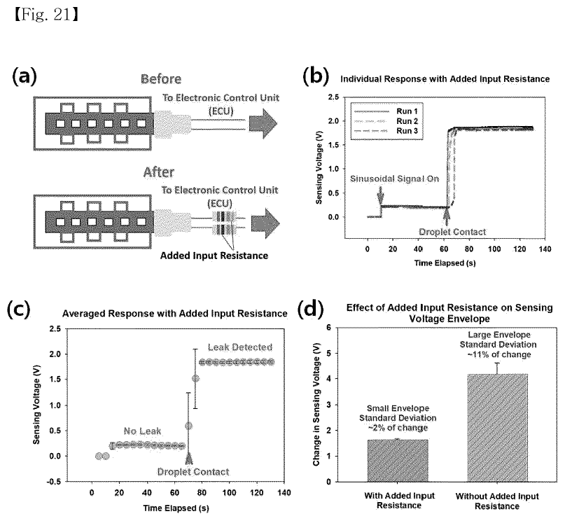

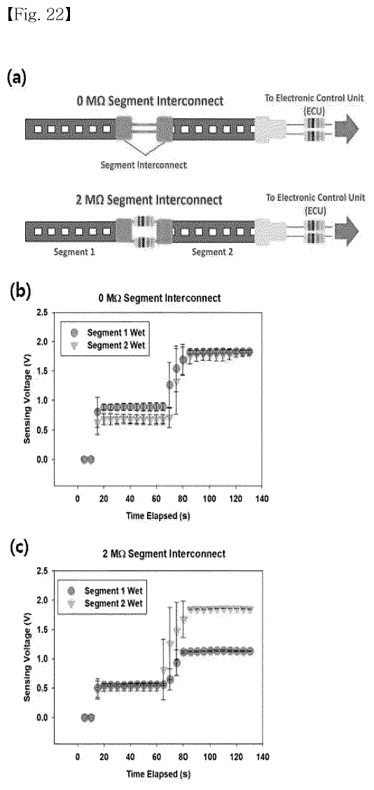

Unlike the embodiment of the present invention described above, according to a first modified example of the present invention, a third electrode, a fourth electrode, a third insulating tape, and a fourth insulating tape having a plurality of holes, configured to block external electrical interference, may be additionally provided. Hereinafter, a fluid leak detection sensor according to a first modified example of the present invention will be described with reference to FIG. 13.

FIG. 13 is a three-dimensional view for describing a fluid leak detection sensor according to a first modified example of the present invention.

Referring to FIG. 6, an absorption pad 100 extending in a first direction, a first electrode 210 disposed on a top of the absorption pad 100 and extending in the first direction, and a second electrode 220 disposed at a bottom of the absorption pad 100 and extending in the first direction may be provided.

Referring to FIG. 12, the roll-to-roll process described above may be performed so that a first insulating tape 310 extending in the first direction and having a plurality of first holes 312 spaced apart from each other in the first direction may be arranged on the first electrode 210. In addition, a second insulating tape 320 extending in the first direction and having a plurality of second holes 322 spaced apart from each other in the first direction may be arranged on the second electrode 220.

In detail, each of the first insulating tape 310 and the second insulating tape 320 may include a first area in which a plurality of holes are arranged, and a second area in which the holes are not arranged. Therefore, the first holes 312 of the first insulating tape 310 may be arranged in the first area of the first insulating tape 310. In addition, the second holes 322 of the second insulating tape 320 may be arranged in the first area of the second insulating tape 320. Accordingly, at least some of the first holes 312 and the second holes 322 may overlap each other on a one-to-one basis.

In addition, a third electrode 230 extending in the first direction and having a plurality of third holes 232 spaced apart from each other in the first direction may be arranged on the first insulating tape 310. In addition, a fourth electrode 240 extending in the first direction and having a plurality of fourth holes 242 spaced apart from each other in the first direction may be arranged on the second insulating tape 320.

In detail, each of the third electrode 230 and the fourth electrode 240 may include a first area and a second area as described above. Therefore, the third holes 232 of the third electrode 230 may be arranged in the first area of the third electrode 230. In addition, the fourth holes 242 of the fourth electrode 240 may be arranged in the first area of the fourth electrode 240. Accordingly, at least some of the third holes 232 and the fourth holes 242 may overlap each other on a one-to-one basis. Therefore, at least some of the first holes 312, the second holes 322, the third holes 232, and the fourth holes 242 may overlap each other on a one-to-one basis.

In addition, a third insulating tape 330 extending in the first direction, and having a plurality of fifth holes 332 spaced apart from each other in the first direction and a plurality of sixth holes 334 spaced apart from each other in the first direction may be arranged on the third electrode 230. In addition, a fourth insulating tape 340 extending in the first direction, and having a plurality of seventh holes 342 spaced apart from each other in the first direction and a plurality of eighth holes 344 spaced apart from each other in the first direction may be disposed on the fourth electrode 240.

In detail, each of the third insulating tape 330 and the fourth insulating tape 340 may include a first area and a second area as described above. Although the second area has been defined as an area in which a plurality of holes are not arranged as described above, as an exception, each of the third insulating tape 330 and the fourth insulating tape 340 may have a plurality of holes arranged in the second area to form a third electrode exposure surface and a fourth electrode exposure surface, which will be described below. Therefore, the fifth holes 332 of the third insulating tape 330 may be arranged in the first area of the third insulating tape 330. In addition, the sixth holes 334 of the third insulating tape 330 may be arranged in the second area of the third insulating tape 330. In addition, the seventh holes 342 of the fourth insulating tape 340 may be arranged in the first area of the fourth insulating tape 340. In addition, the eighth holes 344 of the fourth insulating tape 340 may be arranged in the second area of the fourth insulating tape 340. Accordingly, at least some of the fifth holes 332 and the seventh holes 342 may overlap each other on a one-to-one basis. Therefore, the first holes 312, the second holes 322, the third holes 232, at least some of the fourth holes 242, the fifth holes 332, and the seventh holes 342 may overlap each other on a one-to-one basis. In addition, at least some of the sixth holes 334 and the eighth holes 344 may overlap each other on a one-to-one basis.

Accordingly, the first electrode 210 may have a plurality of first electrode exposure surfaces on a top surface of the first electrode 210 by the first holes 312, the third holes 232, and the fifth holes 332. In addition, the second electrode 220 may have a plurality of second electrode exposure surfaces on a top surface of the second electrode 220 by the second holes 322, the fourth holes 242, and the seventh holes 342. Therefore, at least some of the first electrode exposure surfaces and the second electrode exposure surfaces may overlap each other on a one-to-one basis.

In addition, the third electrode 230 may have a plurality of third electrode exposure surfaces on a top surface of the third electrode 230 by the sixth holes 334, and the fourth electrode 240 may have a plurality of fourth electrode exposure surfaces on a top surface of the fourth electrode 240 by the eighth holes 344. Therefore, at least some of the third electrode exposure surfaces and the fourth electrode exposure surfaces may overlap each other on a one-to-one basis.

In addition, an adhesive tape extending in the first direction, and having a plurality of ninth holes spaced apart from each other in the first direction and a plurality of tenth holes spaced apart from each other in the first direction may be arranged on the fourth insulating tape 340.

In detail, at least some of the ninth holes of the adhesive tape and the seventh holes 342 of the fourth insulating tape 340 may overlap each other on a one-to-one basis. In addition, at least some of the tenth holes of the adhesive tape and the eighth holes 344 of the fourth insulating tape 340 may overlap each other on a one-to-one basis.

Therefore, the fluid leak detection sensor 510 according to the first modified example of the present invention, which includes the first electrode exposure surface, the second electrode exposure surface, the third electrode exposure surface, and the fourth electrode exposure surface may be manufactured.

The first electrode exposure surface and the second electrode exposure surface may be connected to an electronic unit control unit configured to apply an alternating current and a driving frequency to the first electrode 210 and the second electrode 220. Accordingly, changes in a capacitance and a resistance between the first electrode 210 and the second electrode 220 may be measured according to an introduction state of the fluid into the absorption pad 100 and a flow rate of the fluid.

The third electrode exposure surface and the fourth electrode exposure surface may be connected to a ground unit configured to block external electrical interference. Therefore, the external electrical interference affecting the alternating current and the driving frequency applied to the first electrode 210 and the second electrode 220 may be minimized. Accordingly, sensing accuracy of the fluid leak detection sensor 510 may be improved.

Hereinafter, specific experiments and characteristic evaluations of a fluid leak detection sensor according to an embodiment of the present invention will be described.

(a) of FIG. 14 is a graph obtained by theoretically calculating a sensing voltage of a fluid leak detection sensor according to an embodiment of the present invention for each driving frequency condition of the fluid leak detection sensor before and after a leak, and (b) of FIG. 14 is a graph showing a difference in the sensing voltage of the fluid leak detection sensor according to the embodiment of the present invention for each driving frequency condition of the fluid leak detection sensor.

Referring to (a) of FIG. 14, a sensing voltage of a fluid leak detection sensor was theoretically calculated for each driving frequency condition (10 Hz, 50 Hz, 100 Hz, 500 Hz, 1 kHz, and 5 kHz) of the fluid leak detection sensor according to the present invention before and after a leak. The sensing voltage of the fluid leakage detection sensor before the leak was calculated by <Mathematical Formula 1> as follows, and the sensing voltage of the fluid leakage detection sensor after the leak was calculated by <Mathematical Formula 2> as follows. Referring to (b) of FIG. 14, a difference between the sensing voltage of the fluid leak detection sensor after the leak and the sensing voltage of the fluid leak detection sensor before the leak, which were calculated in (a) of FIG. 14, was calculated for each driving frequency condition.

As can be found in (a) of FIG. 14, the sensing voltage of the fluid leak detection sensor before the leak was increased as the driving frequency increases. In contrast, it may be found that the sensing voltage of the fluid leak detection sensor after the leak was less than about 4.55 V regardless of the driving frequency condition.

As can be found in (b) of FIG. 14, when the driving frequency is 10 Hz, the difference in the sensing voltage of the fluid leak detection sensor was 4.54 V, which is the highest.

$$\\ \begin{matrix}Sensing voltage before leak = {V}_{in} \times ( ( {R}_{s} ) / ( {R}_{s} + ( 1 / j ω {c}_{s} ) ) & < Mathematical Formula 1 >\end{matrix}$$

$$\\ \begin{matrix}Sensing voltage after leak = {V}_{in} \times {R}_{s} / ( {R}_{s} + {Z}_{seg} ) , & < Mathematical Formula 2 >\end{matrix}$$

$$\\ wherein {Z}_{seg} = {R}_{1} + ( ( {R}_{2} / j ω {c}_{2} ) / ( 1 + ( ( {R}_{2} / j ω {c}_{2} ) )$$

FIG. 15 is a view for describing a test method for a fluid leak detection sensor according to an embodiment of the present invention, (a) to (c) of FIG. 16 are graphs obtained by measuring the sensing voltage of the fluid leak detection sensor according to the embodiment of the present invention by the test method of FIG. 15, and (d) of FIG. 16 is a graph showing an average sensing voltage of the fluid leak detection sensor according to the embodiment of the present invention, which is obtained based on the sensing voltages measured in (a) to (c) of FIG. 16.

Referring to FIG. 15, a fluid leak detection sensor according to the present invention was prepared with a length of 100 mm, and in order to create a test environment in which a leak occurred in a pipe through which a fluid flows, an acrylic substrate was arranged at a bottom of the fluid leak detection sensor instead of the pipe. In addition, a water droplet was provided to an absorption pad of the fluid leak detection sensor instead of the fluid leaking from the pipe by using a pipette. In addition, a conductive clip was arranged at an end of the fluid leak detection sensor to connect the fluid leak detection sensor to an electronic unit control unit (a function generator, a peak detector, a DC power supply, a data logger, and a computer). In addition, a sine wave driving frequency was applied to the fluid leak detection sensor, the water droplet was provided, and a sensing voltage of the fluid leak detection sensor was measured three times. The sensing voltage of the fluid leak detection sensor was measured in three steps. The sensing voltage was measured before applying the sine wave driving frequency in a first step (from about 0 second to about 10 seconds), the sensing voltage was measured after applying the sine wave driving frequency (10 Hz) in a second step (from about 10 seconds to about 70 seconds), and the sensing voltage was measured by providing the water droplet (5 uL) while the sine wave driving frequency (10 Hz) is applied in a third step (from about 70 seconds to about 140 seconds). Referring to (a) to (c) of FIG. 16, the test method described above in FIG. 15 was used to apply the sine wave driving frequency of 10 Hz to the fluid leak detection sensor according to the present invention and provide the water droplet of 50 uL to the fluid leak detection sensor according to the present invention, and the sensing voltage of the fluid leak detection sensor was measured one time, two times, and three times. Referring to (d) of FIG. 16, an average value of the sensing voltages of the fluid leak detection sensor, which are measured in (a) to (c) of FIG. 16, was calculated every 5 seconds.

As can be found in FIGS. 15 and (a) to (d) of FIG. 16, the sensing voltage of the fluid leak detection sensor was about 0 V before the sine wave driving frequency is applied to the fluid leak detection sensor. In addition, it may be found that the sensing voltage of the fluid leak detection sensor was less than about 0.1 V after the sine wave driving frequency is applied to the fluid leak detection sensor. In addition, it may be found that the sensing voltage of the fluid leak detection sensor was about 4.2 V after the sine wave driving frequency is applied to the fluid leak detection sensor, and the water droplet was provided to the fluid leak detection sensor.

(a) to (d) of FIG. 17 are graphs obtained by measuring the sensing voltage of the fluid leak detection sensor according to the embodiment of the present invention for each sine wave driving frequency condition, (a) of FIG. 18 is a graph obtained by measuring a sensing voltage by applying a sine wave driving frequency of 5 kHz to the fluid leak detection sensor according to the embodiment of the present invention, and (b) of FIG. 18 is a graph showing a difference in the sensing voltages of the fluid leak detection sensor according to the embodiment of the present invention, which are measured in (a) to (d) of FIG. 17 and (a) of FIG. 18.

Referring to (a) of FIG. 17, the test method described above in FIG. 15 was used to apply a sine wave driving frequency of 50 Hz to the fluid leak detection sensor according to the present invention and provide a water droplet of 50 uL to the fluid leak detection sensor according to the present invention, the sensing voltage of the fluid leak detection sensor was measured three times, and an average sensing voltage value was calculated every 5 seconds. Referring to of (b) of FIG. 17, the test method described above in FIG. 15 was used to apply a sine wave driving frequency of 100 Hz to the fluid leak detection sensor according to the present invention and provide a water droplet of 50 uL to the fluid leak detection sensor according to the present invention, the sensing voltage of the fluid leak detection sensor was measured three times, and an average sensing voltage value was calculated every 5 seconds. Referring to (c) of FIG. 17, the test method described above in FIG. 15 was used to apply a sine wave driving frequency of 500 Hz to the fluid leak detection sensor according to the present invention and provide a water droplet of 50 uL to the fluid leak detection sensor according to the present invention, the sensing voltage of the fluid leak detection sensor was measured three times, and an average sensing voltage value was calculated every 5 seconds. Referring to (d) of FIG. 17, the test method described above in FIG. 15 was used to apply a sine wave driving frequency of 1 kHz to the fluid leak detection sensor according to the present invention and provide a water droplet of 50 uL to the fluid leak detection sensor according to the present invention, the sensing voltage of the fluid leak detection sensor was measured three times, and an average sensing voltage value was calculated every 5 seconds. Referring to (a) of FIG. 18, the test method described above in FIG. 15 was used to apply a sine wave driving frequency of 5 kHz to the fluid leak detection sensor according to the present invention and provide a water droplet of 50 uL to the fluid leak detection sensor according to the present invention, the sensing voltage of the fluid leak detection sensor was measured three times, and an average sensing voltage value was calculated every 5 seconds. In (b) of FIG. 18, a difference in the sensing voltages of the fluid leak detection sensor measured in (a) to (d) of FIG. 17 and (a) of FIG. 18 was calculated.

As can be found in (a) to (d) of FIG. 17 and (a) of FIG. 18, according to the fluid leak detection sensor as described above in (a) and (b) of FIG. 14, it may be found that the sensing voltage of the fluid leak detection sensor was increased as the applied driving frequency increases before the water droplet is provided. In addition, when the water droplet is provided, it may be found that the sensing voltage of the fluid leak detection sensor was less than 4.5 V regardless of the applied driving frequency.

As can be found in (b) of FIG. 18, when the sine wave driving frequency of 10 Hz is applied, the difference in the sensing voltage was 4.17 V, which is the highest.

(a) to (c) of FIG. 19 are graphs obtained by measuring a sensing voltage by applying a square wave driving frequency to the fluid leak detection sensor according to the embodiment of the present invention, and (d) of FIG. 19 is a graph showing an average value of the sensing voltages of the fluid leak detection sensor according to an experimental example of the present invention, which are measured in (a) to (c) of FIG. 19.

Referring to (a) to (c) of FIG. 19, the test method described above in FIG. 15 was used to apply a square wave driving frequency of 10 Hz to the fluid leak detection sensor according to the present invention and provide a water droplet of 50 uL to the fluid leak detection sensor according to the present invention, and the sensing voltage of the fluid leak detection sensor was measured one time, two times, and three times. Referring to (d) of FIG. 19, an average value of the sensing voltages of the fluid leak detection sensor measured in (a) to (c) of FIG. 19 was calculated every 5 seconds.

As can be found in (a) to (d) of FIG. 19, when the square wave driving frequency is applied, the sensor voltage of the fluid leak detection sensor was gradually increased to less than about 3.4 V. In addition, when the water droplet is provided while the square wave driving frequency is applied, it may be found that the sensor voltage of the fluid leak detection sensor was increased to less than about 4.4 V.

A factor that caused the above difference is determined to be the application of the square wave driving frequency instead of the sine wave driving frequency to the fluid leak detection sensor.

(a) of FIG. 20 is a graph for comparing differences in sensing voltages measured according to a type of a driving frequency applied to the fluid leak detection sensor according to the embodiment of the present invention, and (b) of FIG. 20 is a graph for comparing differences in sensing voltages measured according to a volume of a water droplet provided to the fluid leak detection sensor according to the embodiment of the present invention.

Referring to (a) of FIG. 20, the test method described above in FIG. 15 was used to apply a sine wave driving frequency (10 Hz) to the fluid leak detection sensor according to the present invention and provide a water droplet of 5 uL to the fluid leak detection sensor according to the present invention, and a difference in the sensing voltage was measured. In addition, the test method described above in FIG. 15 was used to apply a square wave driving frequency (10 Hz) to the fluid leak detection sensor according to the present invention and provide a water droplet of 5 uL to the fluid leak detection sensor according to the present invention, and a difference in the sensing voltage was measured. Referring to (b) of FIG. 20, the test method described above in FIG. 15 was used to apply a sine wave driving frequency (10 Hz) to the fluid leak detection sensor according to the present invention, and a difference in the sensing voltage was measured according to a volume (5 uL, 10 uL, and 50 uL) of a water droplet provided to the fluid leak detection sensor according to the present invention.

As can be found in (a) of FIG. 20, when the sine wave driving frequency is applied to the fluid leak detection sensor, the difference in the sensing voltage was about 4.17 V. In addition, when the square wave driving frequency is applied to the fluid leak detection sensor, it may be found that the difference in the sensing voltage was about 0.93 V. Therefore, it may be found that the difference in the sensing voltage was about 3.24 V higher a case in which the sine wave driving frequency is applied to the fluid leak detection sensor than a case in which the square wave driving frequency is applied to the fluid leak detection sensor. Therefore, it may be found that the application of the sine wave driving frequency to the fluid leak detection sensor is a more efficient scheme for sensing a leak of a fluid than the application of the square wave driving frequency to the fluid leak detection sensor.

As can be found in (b) of FIG. 20, the difference in the sensing voltage of the fluid leak detection sensor was increased as a volume of the water droplet provided to the fluid leak detection sensor increases. Accordingly, it may be found that the difference in the sensing voltage of the fluid leak detection sensor was increased as an amount of the fluid leaking from an inside of the pipe through which the fluid flows increases.

(a) of FIG. 21 is a view for describing first and second test methods for a fluid leak detection sensor according to an embodiment of the present invention, (b) of FIG. 21 is a graph obtained by measuring a sensing voltage by applying a resistor to the fluid leak detection sensor of the present invention according to the first test method, (c) of FIG. 21 is a graph showing an average value of the sensing voltages of the fluid leak detection sensor according to the embodiment of the present invention, which are measured in (b) of FIG. 21, and (d) of FIG. 21 is a graph for comparing standard deviations of differences in the sensing voltages of the fluid leak detection sensor of the present invention according to the first and second test methods.

Referring to (a) of FIG. 21, similar to the test method described above in FIG. 15, a fluid leak detection sensor according to the present invention was prepared with a length of 100 mm, in order to create an environment in which a leak occurred in a pipe through which a fluid flows, an acrylic substrate was arranged at a bottom of the fluid leak detection sensor instead of the pipe, and a water droplet was provided by using a pipette. In addition, a conductive clip was arranged at an end of the fluid leak detection sensor to connect the fluid leak detection sensor to an electronic unit control unit, thereby setting a first test method. In addition, a conductive clip was arranged at an end of the fluid leak detection sensor according to the present invention, and the test method described above in FIG. 15 was used to set a second test method for the fluid leak detection sensor except that two resistors of 1 MΩ were arranged in parallel with each other between the conductive clip and the electronic unit control unit. Referring to (b) of FIG. 21, the second test method was used to apply a sine wave driving frequency of 10 Hz to the fluid leak detection sensor according to the present invention and provide a water droplet of 50 uL to the fluid leak detection sensor according to the present invention, and a sensing voltage was measured one time, two times, and three times. Referring to (c) of FIG. 21, an average value of the sensing voltages of the fluid leak detection sensor measured in (b) of FIG. 21 was calculated every 5 seconds. Referring to (d) of FIG. 21, standard deviations of differences in the sensing voltages of the fluid leak detection sensor according to the present invention measured by using the first test method and the second test method were calculated.

As can be found in (a) to (c) of FIG. 21, when sensing voltage values of the fluid leak detection sensors described above in (a) to (d) of FIG. 16 (measured by using the first test method) are compared to each other, it may be found that the difference in the sensing voltage was smaller in a case in which a resistor is provided to the fluid leak detection sensor (the second test method) than in a case in which the resistor is not provided to the fluid leak detection sensor (the first test method).

As can be found in (d) of FIG. 21, it may be found that the standard deviation of the difference in the sensing voltage was reduced by about 9% in the case in which the resistor is provided to the fluid leak detection sensor (the second test method) as compared with the case in which the resistor is not provided to the fluid leak detection sensor (the first test method). Therefore, a resistor may be provided between the conductive clip connected to the end of the fluid leak monitoring sensor and the electronic unit control unit as a method for reducing a standard deviation of a difference in a sensing voltage of the fluid leak monitoring sensor.

(a) of FIG. 22 is a view for describing third and fourth test methods for a fluid leak detection sensor according to an embodiment of the present invention, (b) of FIG. 22 is a graph showing sensing voltages of a first segment and a second segment according to the third test method, (c) of FIG. 22 is a graph showing sensing voltages of the first segment and the second segment according to the fourth test method, (a) of FIG. 23 is a graph showing differences in the sensing voltages of the first segment and the second segment, which are measured in (b) of FIG. 22, and (b) of FIG. 23 is a graph showing differences in the sensing voltages of the first segment and the second segment, which are measured in (c) of FIG. 22.

Referring to (a) of FIG. 22, two fluid leak detection sensors according to the present invention (a first segment and a second segment) were prepared with a length of 100 mm, and similar to the test method described above in FIG. 15, a third test method was set except that the first segment and the second segment were connected to each other by a connector. In addition, two fluid leak detection sensors according to the present invention (a first segment and a second segment) were prepared with a length of 100 mm, and similar to the test method described above in FIG. 15, a fourth test method was set except that the first segment and the second segment were connected to each other by a connector, and a total resistor of 2 MΩ was provided by connecting two resistors of 1 MΩ in parallel with each other in a middle portion of the connector. Referring to (b) of FIG. 22, a sine wave driving frequency of 10 Hz was applied to the first segment and the second segment according to the third test method, a water droplet of 50 uL was provided to the first segment and the second segment according to the third test method, a sensing voltage was measured one time, two times, and three times, and an average value of the sensing voltages was calculated every 5 seconds. Referring to (c) of FIG. 22, a sine wave driving frequency of 10 Hz was applied to the first segment and the second segment according to the fourth test method, a water droplet of 50 uL was provided to the first segment and the second segment according to the fourth test method, a sensing voltage was measured one time, two times, and three times, and an average value of the sensing voltage was calculated every 5 seconds. Referring to (a) of FIG. 23, differences in the sensing voltages of the first segment and the second segment measured in (b) of FIG. 22 were calculated. Referring to (b) of FIG. 23, differences in the sensing voltages of the first segment and the second segment measured in (c) of FIG. 22 were calculated.

As can be found in (a) to (c) of FIG. 22 and (a) and (b) of FIG. 23, in a case in which a resistor is not applied between the first segment and the second segment (the third test method), it may be found that the difference in the sensing voltage of the first segment was 0.94 V, and the difference in the sensing voltage of the second segment was about 1.12 V.

In contrast, in a case in which the resistor is applied between the first segment and the second segment (the fourth test method), it may be found that the difference in the sensing voltage of the first segment was 0.57 V, and the difference in the sensing voltage of the second segment was about 1.37 V.

Therefore, it may be found that a gap between the difference in the sensing voltage of the first segment and the difference in the sensing voltage of the second segment was larger in the case in which the resistor is applied between the first segment and the second segment (the fourth test method) than in the case in which the resistor is not applied between the first segment and the second segment (the third test method).

Accordingly, a leak location of a fluid may be more accurately found in the case in which the resistor is applied between the first segment and the second segment as compared with the case in which the resistor is not applied between the first segment and the second segment. In addition, it may be found that a spatial resolution of the fluid leak detection sensor according to the present invention was less than or equal to 100 mm.

Although the exemplary embodiments of the present invention have been described in detail above, the scope of the present invention is not limited to a specific embodiment, and shall be interpreted by the appended claims. In addition, it is to be understood by a person having ordinary skill in the art that various changes and modifications can be made without departing from the scope of the present invention.

What is claimed is:

1. A fluid leak detection sensor system comprising:
first and second electrodes spaced apart from each other;
an absorption pad disposed between the first electrode and the second electrode to absorb a fluid;
a first insulating tape disposed on the first electrode, and having a plurality of first holes;
a second insulating tape disposed on the second electrode, and having a plurality of second holes; and
an electronic unit control unit forming electrical contact points with the first electrode and the second electrode through the first hole and the second hole,
wherein the electronic unit control unit includes:
an alternating current signal generator configured to apply an alternating current to the first electrode and the second electrode through the first hole and the second hole;
a peak detector circuit unit configured to measure a change in an impedance value between the first electrode and the second electrode according to the absorption of the fluid performed by the absorption pad;
an electronic communication control unit configured to control the alternating current signal generator and the peak detector circuit unit; and
a pair of pinch electrical connectors configured to connect the electrical contact points formed by the first hole and the second hole to the alternating current signal generator.

2. The fluid leak detection sensor system of claim 1, wherein the fluid includes:
an ionic liquid including tap water, seawater, an acidic solution, a basic solution, or a biological fluid; or
an electrically insulating liquid including hydrocarbon oil, synthetic oil, a polymer fluid, or pure water.

3. The fluid leak detection sensor system of claim 1, wherein the first electrode and the second electrode are spaced apart from each other with the absorption pad interposed therebetween without an air gap,
the first electrode, the absorption pad, and the second electrode are sandwiched between the first insulating tape and the second insulating tape, and
the first hole and the second hole expose the first electrode and the second electrode, respectively.

4. The fluid leak detection sensor system of claim 1, wherein each of the first electrode and the second electrode includes at least one of metal foil, a conductive coating layer on fabric, or a conductive polymer,
the absorption pad includes at least one of paper, cotton, or a polymer, and
the first electrode, the second electrode, and the absorption pad are fixed to each other by using one of sewing, heat bonding, ultrasonic bonding, or an adhesive.

5. The fluid leak detection sensor system of claim 1, wherein a capacitance value or a resistance value between the first electrode and the second electrode is changed according to a state of the absorption of the fluid performed by the absorption pad and an absorption amount of the fluid,
when the absorption of the fluid is not performed by the absorption pad, a portion between the first electrode and the second electrode is modeled as a pure capacitor circuit,
when the absorption of the fluid including an ionic liquid is performed by the absorption pad, a portion between the first electrode and the second electrode is modeled as a Randles circuit having a first resistor and a first capacitor connected in parallel with each other, and a second resistor connected in series with the first resistor and the first capacitor in the pure capacitor circuit, so that an impedance value between the first electrode and the second electrode is reduced, and the reduced impedance value is measured by the peak detector circuit unit, and,
when the absorption of the fluid including an electrically insulating liquid is performed by the absorption pad, a dielectric constant of the absorption pad between the first electrode and the second electrode is reduced to reduce the impedance value, and the reduced impedance value is measured by the peak detector circuit unit.

6. The fluid leak detection sensor system of claim 1, wherein the electronic communication control unit includes:
a data logger configured to store a peak voltage and a value calculated from the peak voltage;
a microcontroller configured to control a duty cycle and a peak voltage sampling rate, and perform calculation for determining a leak location of the fluid, in which the leak location of the fluid is determined by using an impedance value measured through a peak voltage change measured by the peak detector circuit unit; and
a communication module configured to receive the leak location of the fluid from the microcontroller, and including one of Wi-Fi, Bluetooth, ZigBee, infrared communication, RF wireless communication, or Ethernet.

7. The fluid leak detection sensor system of claim 1, wherein the alternating current signal generator generates at least one of a sine wave, a square wave, or a sawtooth wave of 1 Hz to 1 MHz to apply the generated wave to the first electrode and the second electrode.

8. A method for manufacturing a fluid leak detection sensor, the method comprising:
preparing an absorption pad extending in a first direction;
preparing a pair of electrodes extending in the first direction;
preparing a pair of insulating tapes extending in the first direction and having a plurality of holes spaced apart from each other in the first direction; and
arranging the absorption pad between the pair of electrodes, and arranging the pair of electrodes and the absorption pad between the pair of insulating tapes.

9. The method of claim 8, wherein the arranging of the absorption pad between the pair of electrodes and the arranging of the pair of electrodes and the absorption pad between the pair of insulating tapes is performed by using a roll-to-roll process.

10. The method of claim 8, wherein the absorption pad includes at least one of paper, fabric, non-woven fabric, or a polymer.

11. The method of claim 8, wherein the electrode includes aluminum foil, and
the insulating tape includes a masking tape.

12. A fluid leak detection sensor comprising:
an absorption pad extending in a first direction to absorb a fluid;
a first electrode disposed on a top of the absorption pad, and extending in the first direction;
a second electrode disposed at a bottom of the absorption pad, and extending in the first direction;
a first insulating tape disposed on the first electrode, extending in the first direction, and having a plurality of first holes spaced apart from each other in the first direction; and
a second insulating tape disposed on the second electrode, extending in the first direction, and having a plurality of second holes spaced apart from each other in the first direction,
wherein the fluid is absorbed into an exposure surface of the absorption pad disposed between the first electrode and the second electrode.

13. The fluid leak detection sensor of claim 12, wherein the first hole of the first insulating tape and the second hole of the second insulating tape overlap each other.

14. The fluid leak detection sensor of claim 12, wherein an adhesive tape is disposed on the second insulating tape, and
the adhesive tape has a third hole, which overlaps the second hole of the second insulating tape and is identical to the second hole.

15. A fluid leak detection sensor system comprising:
a pipe through which a fluid flows;
the fluid leak detection sensor according to claim 12, which is disposed on the pipe; and
an electronic unit control unit configured to connect a first contact point of a first electrode exposed by a first hole of a first insulating tape to a second contact point of a second electrode exposed by a second hole of a second insulating tape within the fluid leak detection sensor,
wherein the electronic unit control unit outputs different sensing voltage values according to an introduction state of the fluid into an absorption pad of the fluid leak detection sensor through the first contact point of the fluid leak detection sensor and the second contact point of the fluid leak detection sensor, which overlaps the first contact point, to determine whether the fluid leaks from an inside of the pipe.

16. A method for using the fluid leak detection sensor according to claim 12, wherein the fluid leak detection sensor is attached to a pipe through which a fluid flows or a structure in which the pipe is installed in a spiral shape.
